(19) United States
(12) Patent Application Publication
(10) Pub. No.: US 2022/0013902 A1
(43) Pub. Date: Jan. 13, 2022

(54) PHASED ARRAY RADAR DEVICE USING DUAL-FREQUENCY LIQUID CRYSTAL TECHNOLOGY

(71) Applicant: The Regents of the University of Colorado, a body corporate, Denver, CO (US)

(72) Inventors: Dario Bueno-Baques, Colorado Springs, CO (US); Robert Camley, Colorado Springs, CO (US); Zbigniew Celinski, Colorado Springs, CO (US); Anatoliy Glushchenko, Colorado Springs, CO (US); Jason Nobles, Colorado Springs, CO (US)

(21) Appl. No.: 17/371,682

(22) Filed: Jul. 9, 2021

Related U.S. Application Data
(60) Provisional application No. 63/049,931, filed on Jul. 9, 2020.

(51) Int. Cl. H01Q 3/26; H01P 1/18; H01Q 3/22

(52) U.S. Cl. CPC H01Q 3/2676; H01Q 3/22; H01P 1/184

(57) ABSTRACT

This disclosure describes systems, methods, and apparatus for beam steering of a circuit-board based phase array of antennas. An RF signal can be distributed via coplanar waveguide conductors to a plurality of microstrip line conductors arranged in a dual-frequency liquid crystal medium. A low frequency control signal can be injected into each of the microstrip line conductors, preferably while each line is still in a coplanar waveguide form. This low frequency control signal modified a local permittivity of the dual-frequency liquid crystal in the vicinity of a corresponding one of the microstrip lines, thereby imparting a controlled phase delay to the RF signal on each microstrip line. This in turn allows a phase-controlled RF signal to be received at each antenna in the array.

### CLAIM OF PRIORITY UNDER 35 U.S.C. § 119

The present Application for Patent claims priority to Provisional Application No. 63/049,931 entitled “PHASED ARRAY RADAR DEVICE USING DUAL-FREQUENCY LIQUID CRYSTAL TECHNOLOGY” filed Jul. 9, 2020, and assigned to the assignee hereof and hereby expressly incorporated by reference herein.

### FIELD OF THE DISCLOSURE

The present disclosure relates generally to phased array antennas. In particular, but not by way of limitation, the present disclosure relates to systems, methods and apparatuses for steering a radar beam generated by a phased array of antennas.

### DESCRIPTION OF RELATED ART

Phased array radar systems steer a radar beam electronically without moving parts. This is most often achieved with an array of antennas each having its own phase offset. However, decreasing sizes and increasing scan speeds of these phased arrays are reaching practical limits.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as a driver for a microwave phased antenna array comprising a circuit board section, a liquid crystal section, and AC bias electronics. The circuit board section can include an RF input, N liquid crystal section inputs, N liquid crystal section outputs, a means to distribute power, N low frequency AC bias inputs, and a liquid crystal aperture or notch. The RF input can be configured to carry a high frequency signal. The N liquid crystal section outputs are each configured to coupled to one of N RF antennas. The means to distribute power can be a means to distribute power from the RF input to the N low frequency liquid crystal section inputs. The N low frequency AC bias inputs can each couple to a corresponding one of the N liquid crystal section inputs. The N low frequency bias inputs are each coupled to a corresponding one of the N liquid crystal section inputs. The liquid crystal section is arranged in the liquid crystal aperture of notch and in electrical communication with the N liquid crystal section outputs. The liquid crystal section can include a liquid crystal medium with N signal lines passing therethrough, each of the N signal lines coupled to one of the N liquid crystal section inputs and one of the N liquid crystal section outputs. The AC bias electronics can be coupled to the N low frequency AC bias inputs and can be configured to provide low frequency control signals to the N signal lines. The low frequency control signals can control a phase delay of the high frequency signal on each of the N signal lines by changing a localized permittivity of the liquid crystal medium around each of the N signal lines.

Other embodiments of the disclosure may also be characterized as a phased-array antenna comprising an array of N RF antennas, a circuit board section, a liquid crystal section, and bias electronics. The circuit board section can include an RF power divider configured to distribute a high frequency signal to N signal lines in a liquid crystal section. The liquid crystal section can include a liquid crystal medium and the N signal lines, each of the N signal lines can be configured to carry a 1/N^{th} portion of the high frequency signal between the RF power divider and the array of N RF antennas. The bias electronics can be coupled to the RF power divider and be configured to inject N low frequency control signals onto the N signal lines. The voltage and frequency of each of the N low frequency control signals can control a localized permittivity of the liquid crystal medium around a corresponding one of the N signal lines such that the bias electronics effect beam steering of the array of N RF antennas.

Other embodiments of the disclosure can be characterized as a method for controlling a direction of a microwave beam generated by a phased array antenna. The method can include distributing an RF input to a plurality of microstrip signal lines within a dual-frequency liquid crystal medium. The method can further include injecting a low frequency control signal into the plurality of microstrip signal lines. The method can further include adjusting a frequency and voltage of at least one of the low frequency control signals to change a localized permittivity of the liquid crystal medium surrounding a corresponding one of the microstrip signal lines and thereby imparting controlled phase delay to RF power passing through the microstrip signal lines. The method can yet further include delivering the RF power in each microstrip signal line to a corresponding RF antenna in the phased array antenna.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 is a phased array antenna system comprising a circuit board section, a liquid crystal section, and AC bias electronics on the circuit board section;

FIG. 2 is a system phased array antenna comprising a circuit board section, a liquid crystal section, and AC bias electronics that are not on the circuit board section;

FIG. 3 is an assembled phased array antenna system including the driver;

FIG. 4A shows a circuit board section of an embodiment of a phased array antenna system with a liquid crystal aperture;

FIG. 4B shows assembly of a liquid crystal section into the liquid crystal aperture of FIG. 4A;

FIG. 5 illustrates an exploded view of a liquid crystal section of a phased array antenna system;

FIG. 6 illustrates a cross section of an embodiment of a liquid crystal section where the ground plane and microstrip lines are separated by spacers and a liquid crystal medium;

FIG. 7 illustrates a portion of a phased array antenna system showing details of how a liquid crystal section is assembled with and makes electrical contacts to a circuit board section;

FIG. 8 illustrates details of a transition region between a microstrip line of a liquid crystal section and a coplanar waveguide of a circuit board section;

FIG. 9 illustrates an embodiment of a portion of the AC bias electronics seen in FIGS. 1 and 2;

FIG. 10 illustrates an embodiment of the timing circuitry of FIG. 9;

FIG. 11 illustrates an embodiment of the bipolar voltage pre-loader of FIG. 9;

FIG. 12 illustrates an embodiment of the charge storage of FIG. 9;

FIG. 13 illustrates a variation of FIG. 9 showing additional details of the bias sub system of FIG. 9;

FIG. 14A shows a first exemplary plot of a low frequency control signal and a resulting change in liquid crystal permittivity;

FIG. 14B shows a second exemplary plot of a low frequency control signal and a resulting change in liquid crystal permittivity;

FIG. 15 shows an implementation where one or more phase shift boards are used distinct from a board comprising the low frequency AC bias electronics and a board comprising the antennas;

FIG. 16 illustrates a plot of beam steering response time over 10 degrees of angle adjustment;

FIG. 17 illustrates a simulation of beam steering concentration based on topologies from the present disclosure;

FIG. 18 illustrates an embodiment of a method for controlling a direction of a microwave beam generated by a phased array antenna; and

FIG. 19 is a block diagram depicting physical components that may be utilized to realize the microcontroller.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

To achieve smaller phased array packages, improve scanning time, and scale to larger arrays, this disclosure discusses a driver for a phased array of microwave frequency antennas fabricated on one or a handful of circuit boards with dual-frequency liquid crystal media providing selective phase shifting to each antenna in the array, along with a novel biasing circuit for localized control of the liquid crystal permittivity in the vicinity of microwave signal paths for each antenna. More particularly, a low frequency control (or bias) signal (e.g., 1-100 KHz) can be passed through a microstrip signal line in the liquid crystal, contained between two substrates (e.g., glass), to control the permittivity of the liquid crystal in the vicinity of the signal line, which in turn effects a phase delay on a high frequency (e.g., MHz to THz) signal passing through the signal line on the way to each of the antennas in the antenna array. While the phase delay or liquid crystal region utilizes microstrips on substrates (e.g., glass), the antennas, low frequency biasing circuitry, and RF power dividers can be fabricated on traditional circuit boards, such as printed circuit board (PCB), to simplify fabrication and reduce the size of these components. This disclosure will discuss the system architecture, integration of circuit board and liquid crystal sub-systems, electronic control of each antenna's phase, and packaging options to achieve large antenna arrays.

U.S. Pat. Nos. 10,141,620, US10,629,973 and 10,320,089 and related publications disclose other approaches to achieve phase delay by controlling the permittivity of liquid crystal materials. This prior art differs substantially from that described in this disclosure in terms of system architecture, proposed liquid crystal materials and thus the electronic implementation to develop a phase shifter or phased array system. The use of dual-frequency liquid crystal materials (which was not considered in the publications above) provides distinctive speed advantages to the above-noted prior art. Furthermore, the herein disclosed phased array can provide a tunable 360 differential phase shift at improved speeds when combined with the herein disclosed novel biasing circuit capable of fully exploiting the properties of dual-frequency liquid crystals in contrast to the above-noted prior art.

Preliminary note: the flowcharts and block diagrams in the following Figures illustrate the architecture, functionality, and operation of possible implementations of systems, methods and computer program products according to various embodiments of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### System Architecture

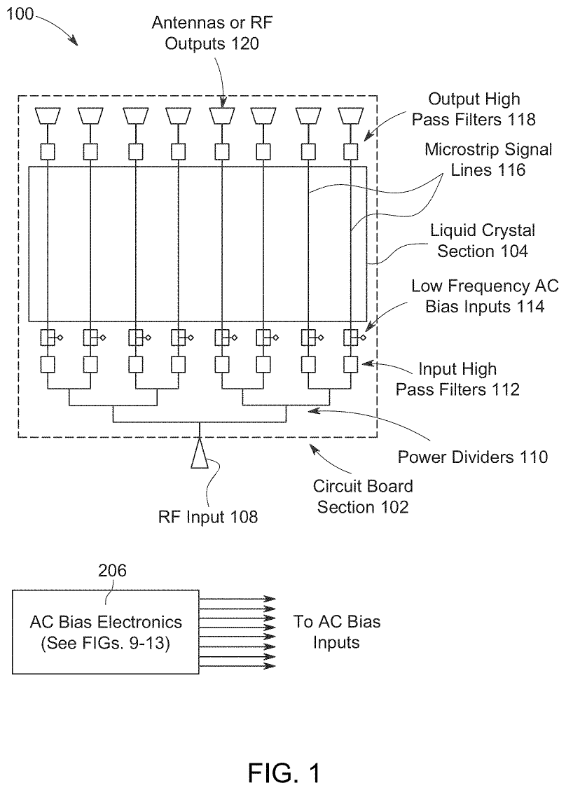

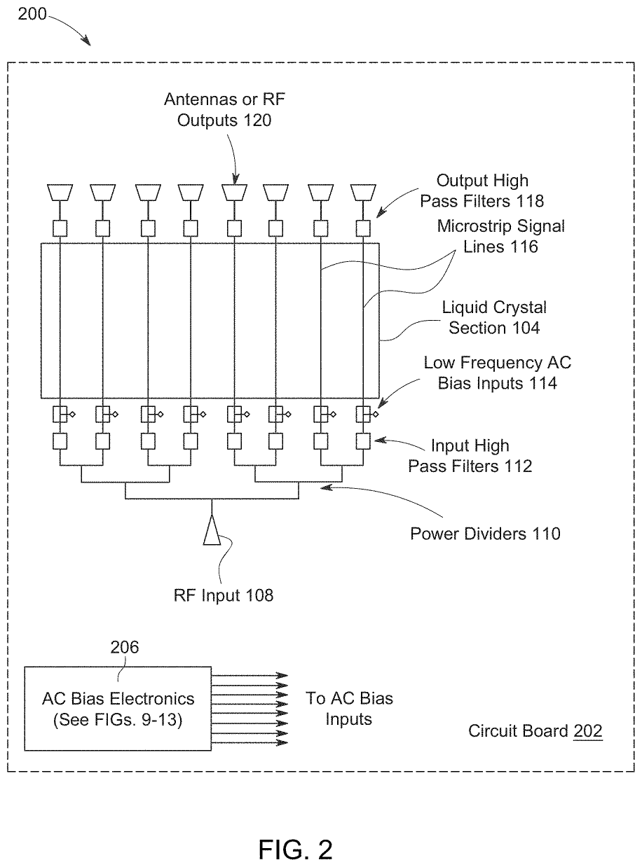

The system 100/200, as shown in FIGS. 1-4, largely comprises a circuit board section 102 and a liquid crystal section 104. The circuit board section 102/202 comprises an RF input 108, power dividers 110, low frequency AC bias inputs 114, two sets of high pass filter components (input 112 and output 118), and the antenna array (or connectors to an antenna array) 120. Additionally, the circuit board section 202 in FIG. 2 includes low frequency bias electronics 106, whereas in FIG. 1, the low frequency bias electronics 106 are remote from the circuit board section 102. The liquid crystal section 104 can be arranged between the low frequency AC bias inputs 114 and the output high pass filter components 118. The input high pass filter components 112 can be arranged between the power dividers 110 and the low frequency AC bias inputs 114. While phase delaying attempts have been made in the past using glass substrates, the biasing electronics and power dividers have typically been fabricated on glass, which creates certain hurdles that this disclosure overcomes by moving as much of the system to a traditional circuit board as possible. However, this generates new challenges in integrating the glass (or liquid crystal 104) and circuit board sections 102/202 of the system that will be discussed later in this disclosure.

The power input to the single RF input 108 (e.g., single end launch connector) can be split into a line for each antenna in the array via the power dividers 110 (e.g., Wilkinson dividers). Each of these power lines can be fabricated as a microstrip waveguide on the circuit board section 102/202, though other microwave topologies are also possible. Each line can pass through one of the high pass filter components 112, such as a capacitor, and is then joined with a low frequency control signal (e.g., 1 kHz to 50 kHz) at one of the low frequency AC bias inputs 114. Each of these low frequency AC bias inputs 114 can receive a low frequency AC signal from the bias electronics 106/206. Each low frequency AC signal, or low frequency control signal, can be configured to control a localized permittivity of the liquid crystal medium in the vicinity of a microstrip signal line 116 passing through the liquid crystal section 104. In other words, all microstrip signal lines 116 in the liquid crystal section 104 carry the same high frequency RF signal (e.g. MHz to THz) from the RF input 108 as well as a unique low frequency control signal (e.g. 1-100 KHz) configured to control the phase delay for each line 116. By localized permittivity, it is meant that each signal line 116 only controls so much of the liquid crystal volume, that there is negligible cross talk between signal lines 116 within the liquid crystal section 104 (in terms of the effects of liquid crystal permittivity).

For the purposes of this disclosure, a “driver” of the antennas or RF outputs 120 shall include all components and circuitry upstream from the antennas or RF outputs 120.

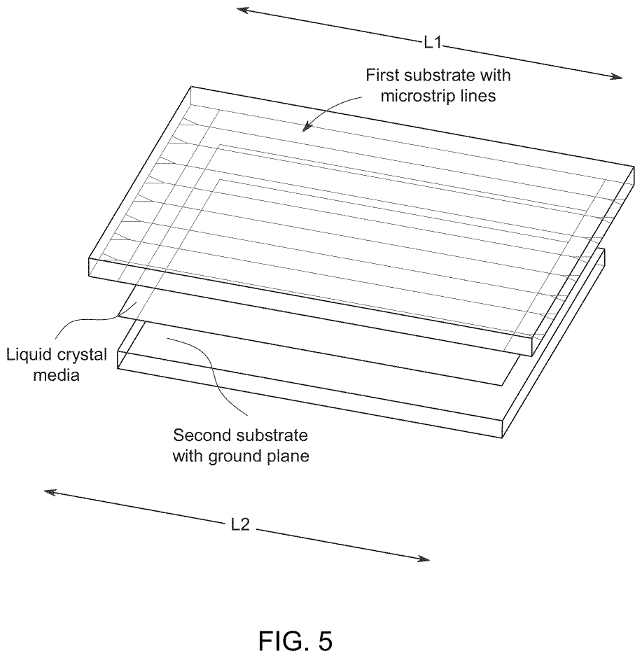

To better understand the workings of this low frequency control signal, it should be noted that dielectric properties of liquid crystals are related to the response of liquid crystal molecules to an applied electric field. Permittivity is a physical quantity that describes the ability of a material to be polarized in response to an applied electric field. Here, the low frequency components of signals passing through the microstrips 116 in the liquid crystal section 102 generate a localized electric field between the microstrip signal line 116 and the ground plane (see ground plane in FIGS. 5, 6, 7), and this localized field in the liquid crystal near the signal line 116 controllably polarizes and orients the molecules in the liquid crystal material and controls the local permittivity of the liquid crystal. This change in permittivity near the microstrip line 116, in turn, effects a phase delay on the RF or high frequency component of the signal passing through the microstrip line 116.

Since the low frequency control signals are used to control a permittivity of the liquid crystal, the high pass filter components 112, 116 can be arranged before the low frequency AC bias inputs 114 and after the liquid crystal section 104, thereby precluding all but the high frequency RF signals from reaching the antennas 120, and preventing the low frequency control signals from reaching the antennas 120 or passing back toward the RF input 108. The high pass filter components 112, 116 also help to minimize cross talk through the power dividers 110. Although capacitors are one embodiment of the high pass filter components 112, 116, any suitable network of components can be implemented.

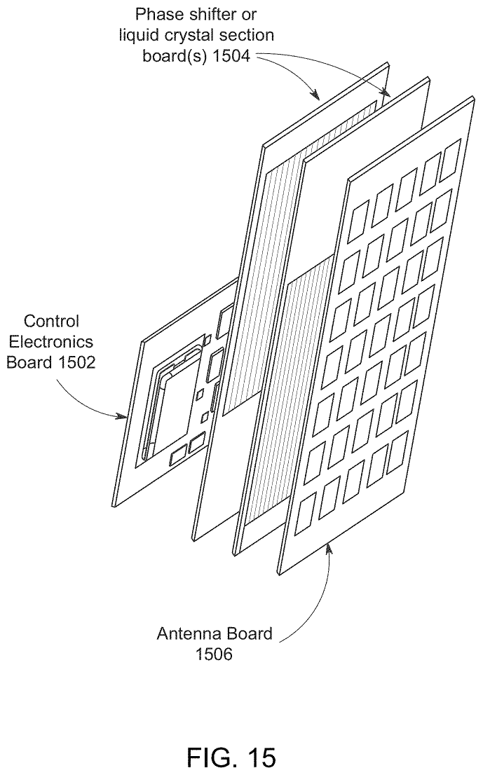

Although FIGS. 1 and 2 show the antennas 120 on the same circuit board 102 as the liquid crystal section 104, in other embodiments, the antennas 120 can be on another board. For instance, FIG. 15 shows an implementation where one or more phase shift boards 1504 are arranged between a board 1502 with the low frequency AC bias electronics and a board 1506 with the antennas. From this example it will be appreciated that the liquid crystal section 104, the low frequency AC bias electronics 106/206, and the antennas 120 can be distributed among any one or more distinct circuit boards or other substrates.

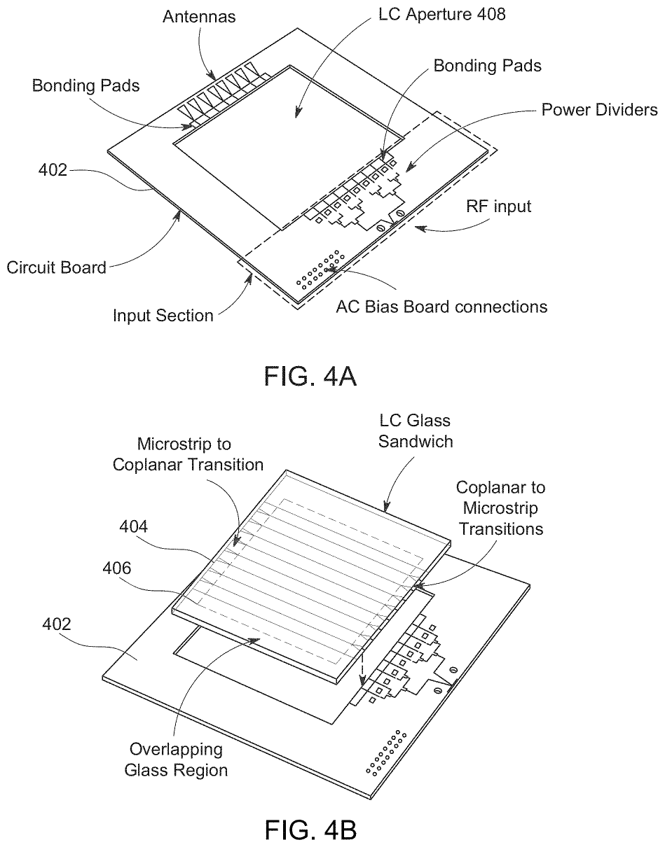

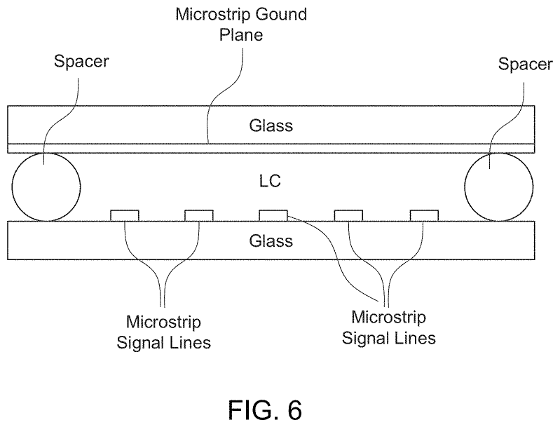

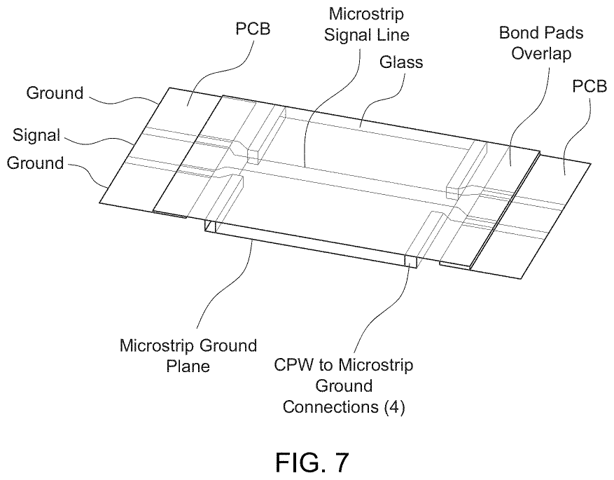

The liquid crystal section can include a plurality of signal lines arranged in parallel as seen in FIGS. 4 and 5 (although a parallel arrangement is not necessary), and spaced sufficiently such that localized changes in liquid crystal permittivity do not influence adjacent signal lines (i.e., negligible low frequency cross talk between adjacent signal lines). In an embodiment, a minimum spacing between signal lines of 300 μm is used. To enhance the phase delay of the liquid crystal on the RF signals, microstrip lines can be used in the liquid crystal section rather than coplanar waveguides. Specifically, the microstrip signal lines can be fabricated on an inner surface of a first substrate (e.g., glass) and a ground plane can be fabricated on an inner surface of a second substrate (e.g., glass). The inner surfaces of the first and second substrates can face each other, and a liquid crystal medium can be arranged between the inner surfaces of the first and second substrates. For instance, the microstrip signal lines can be photolithographically defined on the first or upper substrate and a conductor (e.g., copper, with thickness on the order of a couple skin depths, for instance, 2 μm) can be deposited on the first or upper substrate (e.g., with a magnetron sputtering system). A conductive ground plane (e.g., copper or 2 μm copper) can also be deposited on an inner surface of the second or lower substrate. The liquid crystal medium can then be sandwiched between these two inner surfaces as shown in FIGS. 5 and 6, and spacers can be used to separate the two substrates (e.g., 20-50 μm spacers, such as glass spacers, deposited on the ground plane during assembly). A thickness of the liquid crystal media can be selected to optimize impedance matching and high frequency signal transmission (e.g., 25 um to 40 um. The microstrip lines can be arranged on either the top or bottom substrate, though FIGS. 5 and 7 show the microstrip lines arranged on the top glass substrate, which may facilitate connections to the circuit board section . Although the illustrated microstrip signal lines are in a parallel arrangement, other geometries (e.g., meanders, zigzags, chicanes, etc.) may also be used to obtain the necessary signal line length to provide the desired total phase shift of the high frequency signal.

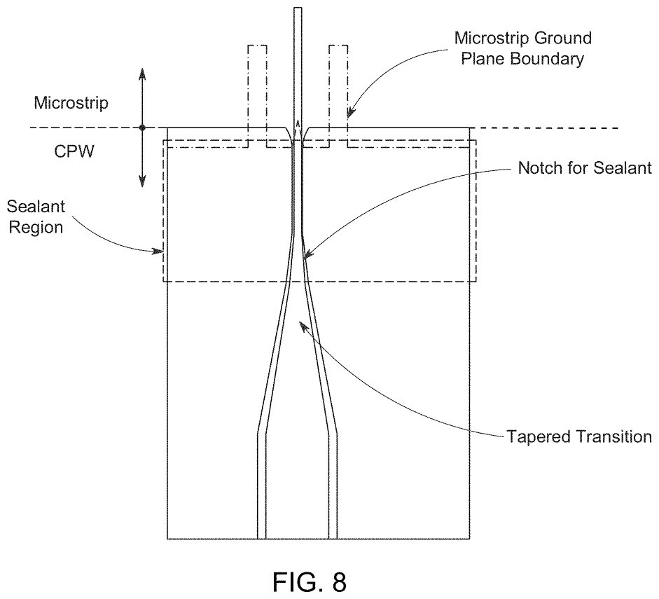

FIG. 8 illustrates an exemplary transition of a coplanar waveguide signal line on a circuit board to the microwave signal line in the liquid crystal section. In particular, the bond pad sites (see bond pad overlap in FIG. 7) use a co-planar waveguide geometry with three conductor lines, the two outer lines for ground and the inner line carrying the AC signals. In this arrangement, the transition is designed to account for several factors: the sealant that holds the substrates together and contains the liquid crystal, the transition from the sealant to the liquid crystal; and the transition from coplanar waveguide to microstrip geometries. The shape and dimensions of these transition regions can be tailored for impedance matching and can depend on the signal line thickness and width, liquid crystal thickness, materials, and frequency of the high frequency RF signal. The liquid crystal section includes a single microstrip line at the same, or roughly the same, level or elevation as the coplanar signal line in the circuit board section. However, the two outer ground lines in the coplanar geometries transition vertically into a ground plane at a lower level or elevation in the liquid crystal section, thus forming an inverted microstrip geometry within the liquid crystal section. This orientation avoids any sharp directional changes in the microstrip line as it maintains the same or roughly the same elevation through the transitions. Liquid crystal media can then be arranged between the ground plane and the signal line. Although not shown, one or more alignment layers in contact with the liquid crystal medium may also be implemented. As one example, a 10 nm layer of polyimide or other polymer, covering the surface of the substrates and metallization, can be uniaxially rubbed to create an alignment layer for the liquid crystal.

The liquid crystal section 404 can be sized to overlap with a portion of the circuit board section 402 as best seen in FIG. 4B. FIG. 4B shows the outline 406 of the liquid crystal aperture 408 superimposed on the liquid crystal section 404. The circuit board section 402 can include bonding pads configured to align with bonding pads of the liquid crystal section 404, such that when the liquid crystal section 404 is lowered onto the circuit board section 402, the bonding pads align, and solder or other bonding means (e.g., a sealant) can be used to make electrical connections between the signal lines on the liquid crystal section 404 and the signal lines on the circuit board section 402.

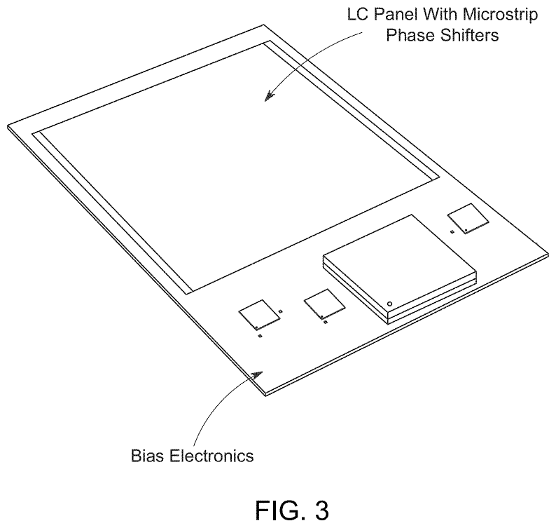

In some embodiments, the bias circuitry may be arranged on the circuit board section. However, in other cases, and as shown for instance in FIGS. 4A and 4B, the bias circuitry may be arranged remote from the circuit board section 402, and low frequency AC bias board connections may be arranged on the circuit board section 402 that can be used to couple to bias signals from bias electronics that are not on the same circuit board (as shown in FIGS. 1 and 15). FIG. 3 illustrates an example of the liquid crystal section coupled to the circuit board section after assembly.

To further help with alignment of the bond pads, the substrate containing the signal lines can be physically longer than the substrate with the ground plane. For instance, FIG. 5 shows a top substrate with the microstrip lines that is longer than the bottom substrate having the ground plane (e.g., L1 is greater than L2 in FIG. 5). In another example, FIG. 7 shows the bond pads overlapping with the circuit board section (PCB) such that a vertical electrical connection can be made between the coplanar waveguide section of the circuit board section and that of the first/upper substrate. In terms of substrates, one could say that the first/upper substrate is longer than the second/lower substrate, and while the second/lower substrate fits into a liquid crystal aperture in the circuit board section, the first/upper substrate overlaps with a small portion of the circuit board section and rests on the circuit board section. This difference in substrate lengths can aid in integrating the liquid crystal section with the circuit board section, but is just one of many packaging approaches, and should thus not be seen as limiting.

The substrates discussed herein can be formed from various materials, have different thicknesses, and encompass different rigidities. As one non-limiting example, the substrates could be glass, silicon or sapphire. In another embodiment, the microstrip signal lines and ground plane could be deposited on thin polymer or dielectric substrates, such as polyester (PET), polyimide (PI), polyethylene naphthalate (PEN), polyetherimide (PEI), along with various fluropolymers (FEP) and copolymers, to name a few non-limiting examples. However, glass does have advantages, for instance, in readily accepting traditional liquid crystal alignment methods used to control initial orientation of liquid crystal media, which aids in maintaining proper phase and time response of the array. As one example, a 10 nm layer of polyimide or other polymer, covering the surface of the substrates and metallization, can be uniaxially rubbed to create an alignment layer for the liquid crystal. Glass also provides strength and rigidity to maintain the internal cell spacing for both the liquid crystal and the microstrip waveguide.

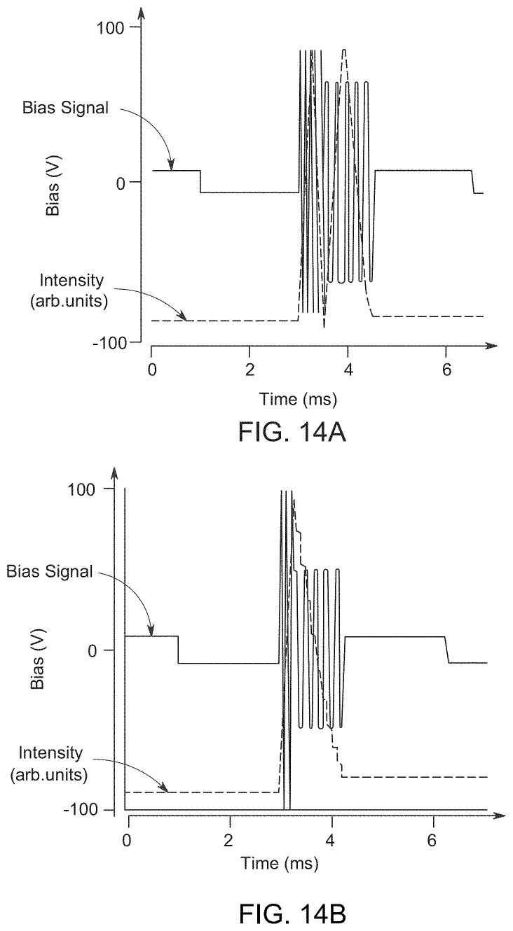

Any liquid crystal media can be utilized, though it was observed that faster switching has been seen with dual-frequency liquid crystals. Dual-frequency nematic liquid crystal permittivity can be controlled by changes in voltage, frequency, or both. FIGS. 14A and 14B show how different bias conditions (low frequency control signal as shown in a solid line) are used to optimize the operation of the dual-frequency nematic liquid crystal. In the tests these graphs represent, the change in the liquid crystal permittivity is related to the number of oscillations in the intensity line (dotted line), i.e., more oscillations indicate a greater change in permittivity. In FIG. 14A, the low frequency control signal is initially at a low voltage and frequency (0-3 ms). The low frequency control signal then transitions to a high voltage and frequency to begin the liquid crystal molecular rotation (3-3.5 ms). The voltage and frequency are then reduced as the molecules rotate to their desired orientation (3.5-4.5 ms). The liquid crystal response is indicated by the intensity curve and the permittivity change is indicated by the oscillations. The low frequency control signal is then reduced back to a new hold condition to maintain the desired permittivity, indicated by the fact that the intensity is now constant. In FIG. 14B, the same transitions are shown for the low frequency control signal, but it is important to note that the changes in the low frequency control signal are of different amplitude, frequency, and duration producing a different change in permittivity. This demonstrates that the low frequency control signal conditions should be tailored to the desired permittivity shift in order to optimize the response time of the liquid crystal. These are exemplary plots and only aim to show the variations in low frequency control signals that may be needed to achieve different permitivities—they are in no way specific to nor limiting of the embodiments herein disclosed.

The result of the innovations herein disclosed is the ability to use frequencies spanning the GHz to THz realm (e.g., a 32 GHz signal) at the RF input, enabling faster scanning (e.g., 42 ms beam switching times) and a smaller system package than has been achieved in the art (e.g., 180 ms switching times). These high frequencies are enabled by the small values of loss parameter of the liquid crystal media.

### Integration of Circuit Board and Liquid Crystal Sub-Systems

By fabricating the low frequency AC bias inputs, bias electronics, power dividers, and RF power input on traditional circuit boards, off-the-shelf components can be used, and the challenges of designing circuits on two-dimensional glass surfaces is largely avoided. Use of a multilayer PCB circuit board allows a simpler topology for transitions between microstrip and coplanar geometries. As discussed previously, the liquid crystal section includes a longer upper substrate than a lower substrate, and a dimension of the upper substrate is longer than a liquid crystal aperture in the circuit board section to enable the longer upper substrate to overlap the circuit board section when mounted. This enables vertical alignment of ground lines in the coplanar sections (the circuit board section) to a ground plane in the microstrip section (the liquid crystal section), and as discussed and illustrated relative to FIG. 7. The overlap in part of the liquid crystal section to the circuit board section also provides support and structural stability. Connectivity is achieved by aligning the circuit board section (coplanar waveguide geometry) with the edge of the liquid crystal section (also coplanar waveguide geometry). Said another way, the transition from coplanar waveguide to microstrip line geometry can take place on the glass substrate or a portion of the liquid crystal section.

### Low Frequency AC Bias Circuits

Since each signal line in the liquid crystal section benefits from independent voltage and frequency control, traditional methods call for a distinct oscillator and voltage source for each signal line. In a large phased array, this requirement becomes impractical. This disclosure describes a novel low frequency AC biasing circuit able to provide individual voltage and frequency biases to each signal line in the liquid crystal section, but without distinct oscillators and voltage sources for each signal line.

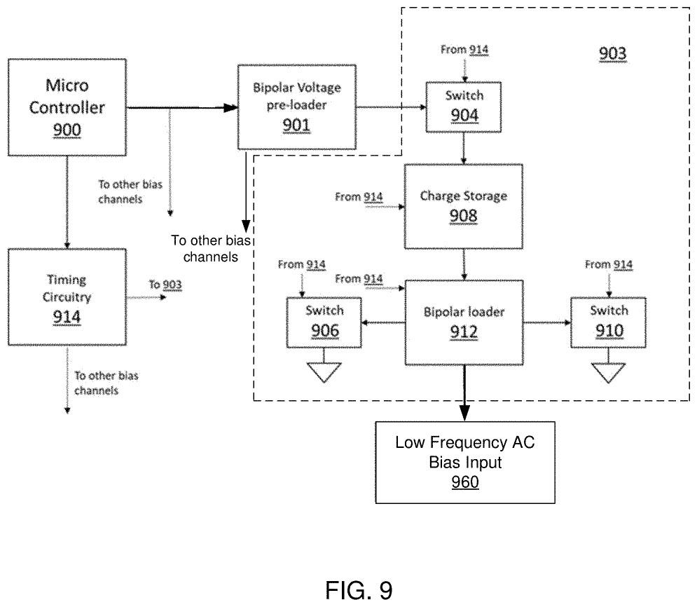

FIG. 9 shows a high-level embodiment of the low frequency AC bias electronics 106/206 generally described in FIGS. 1 and 2. The bias electronics 106/206 can include a plurality of (e.g., N) bias sub-systems 903 (only one of which is shown in FIG. 9), where each bias sub-system 903 injects/adds a low frequency control signal to a signal line in the liquid crystal section. In other words, each of a plurality of bias sub-systems 903 can each be coupled to a distinct one of the low frequency AC bias inputs (e.g., 114 in FIGS. 1 and 2). The plurality of bias sub-systems 903 can be controlled using a central microcontroller unit 900, a timing circuitry 914, and a bipolar voltage pre-loader 901. Further, the low frequency control signals are configured to provide any degree of phase delay to a signal line, and thus the voltage and frequency at the output are continuously variable. The timing circuitry 914 can provide clock signals (dotted lines) to the switches 904, 906, 910, 943, and 944 as well as the charge pumps 933 and 932.

The micro controller 900 can select a pre-loaded voltage for all of the plurality of bias sub-systems 903 via the bipolar voltage pre-loader 901, which then provides its voltage to each of the plurality of sub systems 903. The pre-loader 901 can be embodied by any variety of boost topologies. Each sub-system 903 modifies this pre-loaded voltage via a first switch 904. The timing of switching of the first switch 904 in each sub-system 903 is controlled by a timing circuitry 914, which is controlled by the micro controller 900. The voltage of the pre-loader 901 along with the switching frequency of the first switch 904, determines a charge stored on the charge storage 908 (e.g., via a charge pump or a capacitor). The voltage stored in the charge storage 908 along with cycling of the switches 906 and 910, both controlled by timing circuitry 914, determines an amplitude and frequency of voltage provided to the low frequency AC bias input 960 and thereby to a corresponding signal line in the liquid crystal section. This frequency and voltage determine a localized permittivity of the liquid crystal for the corresponding signal line.

The bipolar loader 912 network provides a low impedance output and connection from the charge storage 908 to the low frequency AC bias input 960.

Although a specific topology for the sub-systems 903 has been illustrated, generally these sub-systems 903 operate to provide a pulsed output to the low frequency AC bias inputs 960, with a controlled voltage and frequency. Thus, any number of different topologies including but not limited to the one shown, can be implemented.

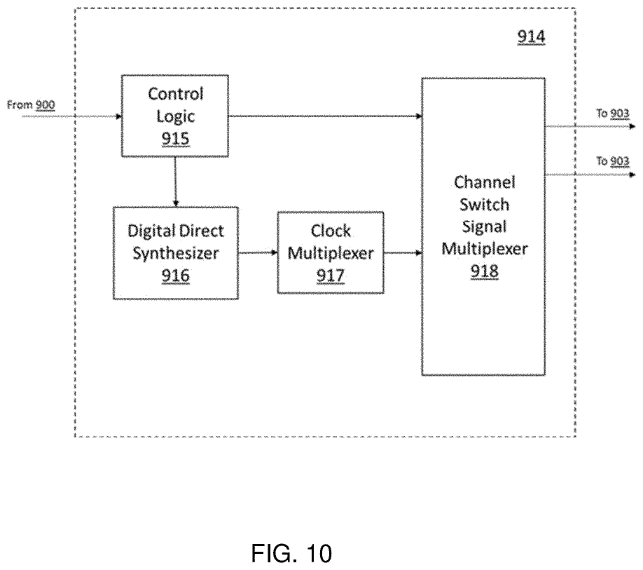

FIG. 10 illustrates a more detailed embodiment of the timing circuitry 914 used to generate the timing signals for the charge storage 908, bipolar loader 912 and switches 904, 906 and 910. A master clocking signal for the charge storage pump used across the bias sub-systems 903 is generated by the timing circuitry 914 that can be based on a digital signal generator controlled by the microcontroller through the control logic interface 915. This control logic 915 allows interfacing and programing of the digital direct synthesizer 916 by the microcontroller 900 and the line selection in the main channel switch signal multiplexer 918.

The clock signal is multiplexed in the clock multiplexer 917 and provided to the channel switch signal multiplexer 918 that distributes the control signals across the bias sub-systems 903.

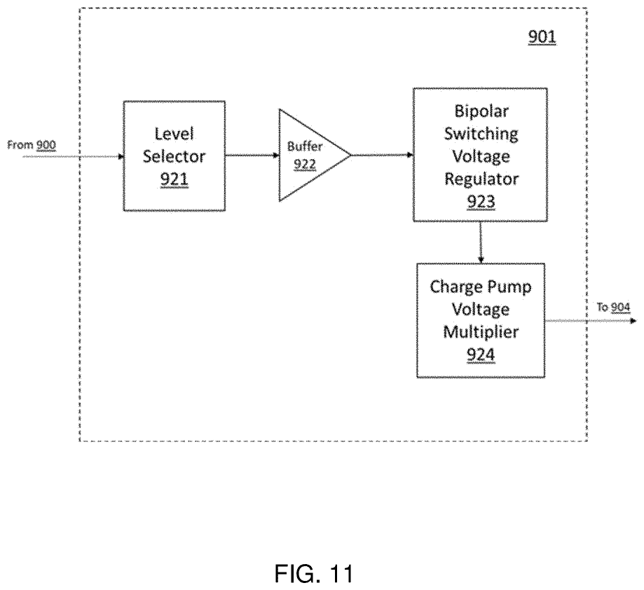

A detailed view of an embodiment of the bipolar voltage preloader 901 is illustrated in FIG. 11, and can include a level selector 921, an impedance matching and conditioning buffer 922, a bipolar voltage switching regulator 923, and a charge pump voltage multiplier 924. This embodiment of the bipolar voltage preloader 901 can generate positive and negative voltages for the charge storage 908. The output voltage levels can be set by the level selector 921 controlled by the microcontroller 900. The voltage output of the regulator 923 can be further multiplied, divided, or used as is by the charge pump 908.

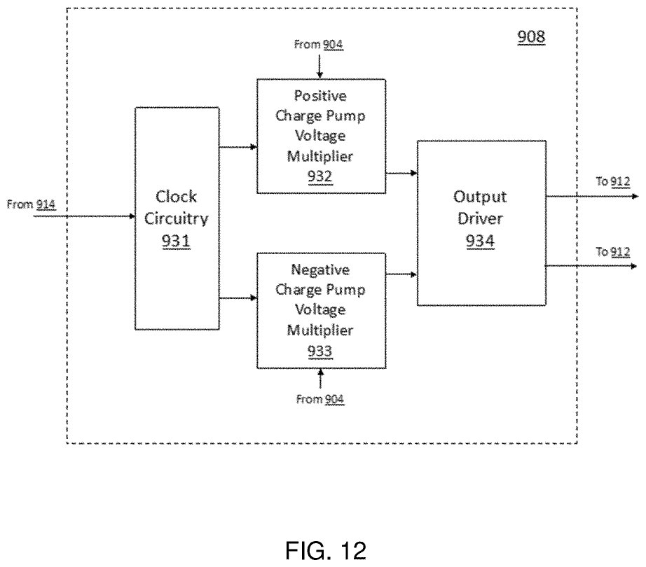

The embodiment in FIG. 12 illustrates details of an implementation of the charge storage 908. A clock circuitry 931 provides simultaneous trigger signals to positive and negative charge pump voltage multipliers 932 and 933. In some embodiments, the clock circuitry 931 is not needed, and the clock signal from the timing circuitry 914 can be provided directly to the charge pumps 932 and 933. The outputs of the charge pumps 932 and 933 are driven into the bipolar loader 912 by means of the output driver 934. Further, the voltage provided to the low frequency AC bias input 960 is controlled by the cycles of the switch 904 and operation of the charge pumps 933, 932. Although the charge storage 908 is shown in a bipolar topology, a unipolar variation is also possible.

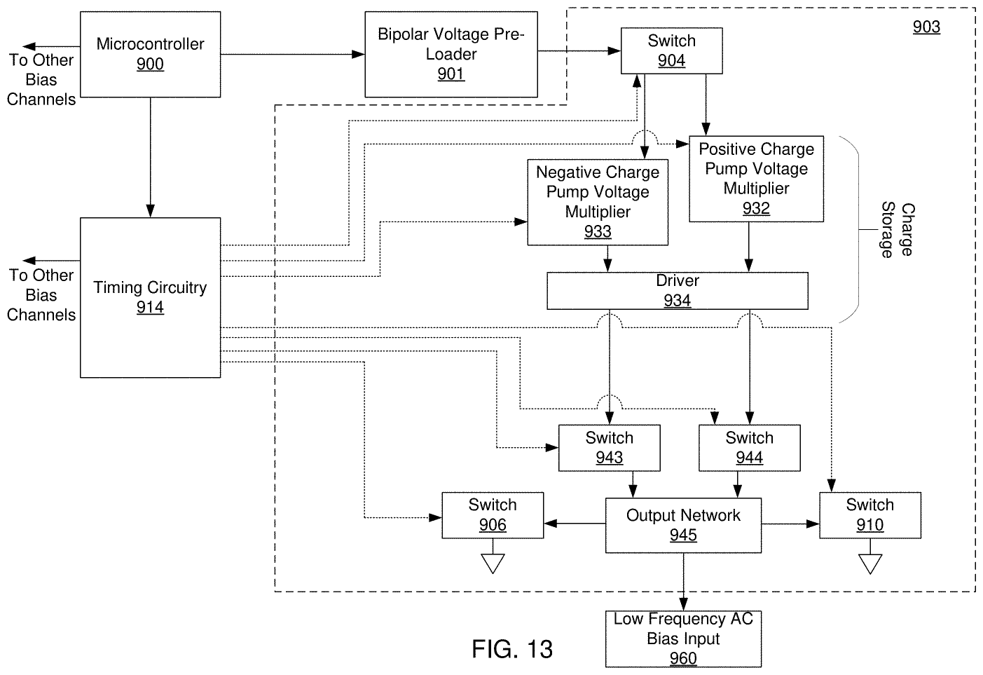

The embodiment in FIG. 13 illustrates an embodiment with additional details of the charge storage 908 and the bipolar loader 912. Specifically, the microcontroller 900 instructs the voltage pre-load 901 to present a desired voltage to the plurality of sub-systems 903, and in particular, to the switch 904 in each sub-system 903. The switch 904 provides a pulsed DC output whose positive components are passed to a positive charge pump voltage multiplier 932 and whose negative components are passed to a negative charge pump voltage multiplier 933. The charge pumps 932, 933 can be embodied by a variety of topologies, but regardless of topology, they can raise the magnitude of the voltage provided by the voltage pre-loader 901. To adjust permittivity on a signal line, the charge pumps 932, 933 can be used to adjust an amplitude of the fluctuating signal provided at the low frequency AC bias input 960. The switches 943, 944 can be timed to

The desired voltage at each low frequency AC bias input 960 for can be set by controlling the load switches 943 and 944. If a desired positive level is higher than the preload level, several charging cycles at 932 with 943 open increase the voltage in the low frequency AC bias input 960 connected through the output network 945. The output network 945 ensures there is low output impedance to the line. Once this voltage is achieved, this voltage is maintained by logically severing or passing the signal at the output driver 934. This process can be self-maintained using comparators and feedback from the output network 945. Further, opening the switch 943 and closing the discharge switch 910, constructs the desired waveform at a given frequency. The same steps can be followed to supply a negative level using the charge pump multiplier 933 and load switch 944. Again, opening and closing switches 944 and 910 the negative half of the desired waveform at a given frequency is achieved. Although the sub-system 903 is shown in a bipolar topology (e.g., two charge pumps 933 and 932 and two switches 943 and 944), a unipolar variation is also possible.

The switch 906 in combination with the switches 943 and 944 can be used to set instantaneous levels below those programmed at the pre-loader 901.

The bias electronics 800, can be arranged on the same circuit board as other components as shown in FIGS. 2 and 3, or on a separate circuit board as shown in FIG. 1.

### Packaging Options to Achieve Large Antenna Arrays

FIG. 15 illustrates an assembly where the low frequency AC bias electronics, antenna array, and liquid crystal section are all three on different circuit boards. Further, this illustration shows that the liquid crystal section can be separated into multiple boards while still using a single 2D antenna array. Specifically, this embodiment shows low frequency AC bias electronics, on a control electronics board 1502, two phase shifter boards (or liquid crystal sections) 1504, and an antenna board 1506. The phase shifter boards 1504 can each include an RF input, power dividers, input high pass filters, low frequency AC bias inputs, a liquid crystal section and output high pass filters. A primary RF signal can be split and equally provided to an RF input to both phase shifter boards 1504. Outputs of signal lines on each phase shifter board 1504 can be routed to corresponding antennas on the antenna board 1506. Since much of the topology shown in FIGS. 1 and 2 are in roughly a single plane, splitting some of these components up onto separate boards and stacking the boards as shown in FIG. 15 allows for a smaller footprint and only a slightly taller package.

FIGS. 1 and 2 show a one-dimensional, linear antenna array. However, two-dimensional arrays can also be implemented (e.g., see FIG. 15's two-dimensional planar antenna array). In another embodiment, multiple one-dimensional antenna boards such as the ones seen in FIGS. 1, 2, and 4 can be stacked to form a two-dimensional antenna array (not shown). In another embodiment, multiple two-dimensional planar antenna arrays (e.g., see FIG. 15) may be arranged to provide a three-dimensional array (not shown). The number of signal lines, biasing elements, antenna, etc. shown in this disclosure are for example and are not limiting of the various topologies and structures that one of skill in the art can implement.

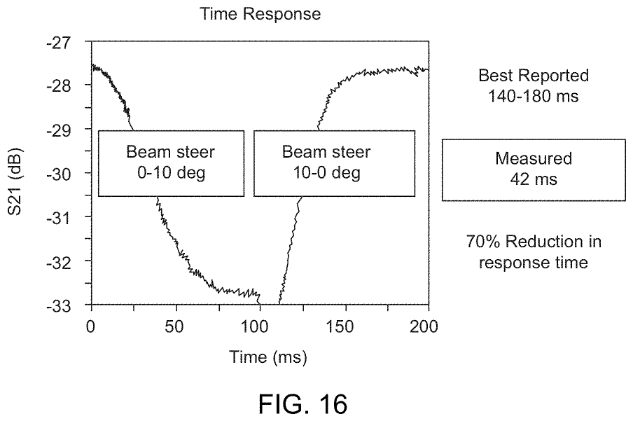

FIG. 16 illustrates a plot of beam steering response time over 10 degrees of angle adjustment. In particular, a phased array according to an embodiment of this disclosure was adjusted over a 10-degree angular adjustment, which was measured to take approximately 42 ms, for both directions of adjustment. This demonstrates a roughly 70% reduction in response time over the best reported beam steering devices known in the art (e.g., 140-180 ms).

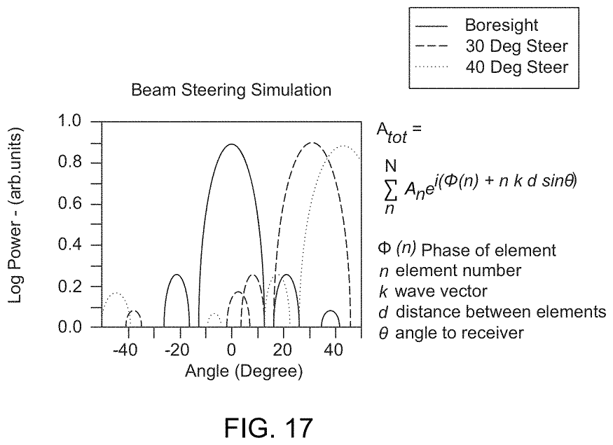

FIG. 17 illustrates a simulation of beam steering concentration based on topologies from the present disclosure. Not only is it important to be able to quickly move a microwave beam across space, but also to do so while maintaining a consistent beam spread. FIG. 17 simulates beam concentration from −50 to +50° for three different angles of beam steering (boresight or 0° of steering, 30° of steering, and 40° of steering). As can be seen in the plot, the width of the primary beam is roughly constant for all three angles and off-target-axis components are effectively controlled to a low power. This simulation supports the results of FIG. 16 in demonstrating not only fast beam steering, but also fast steering with controlled power concentration along a given target angle.

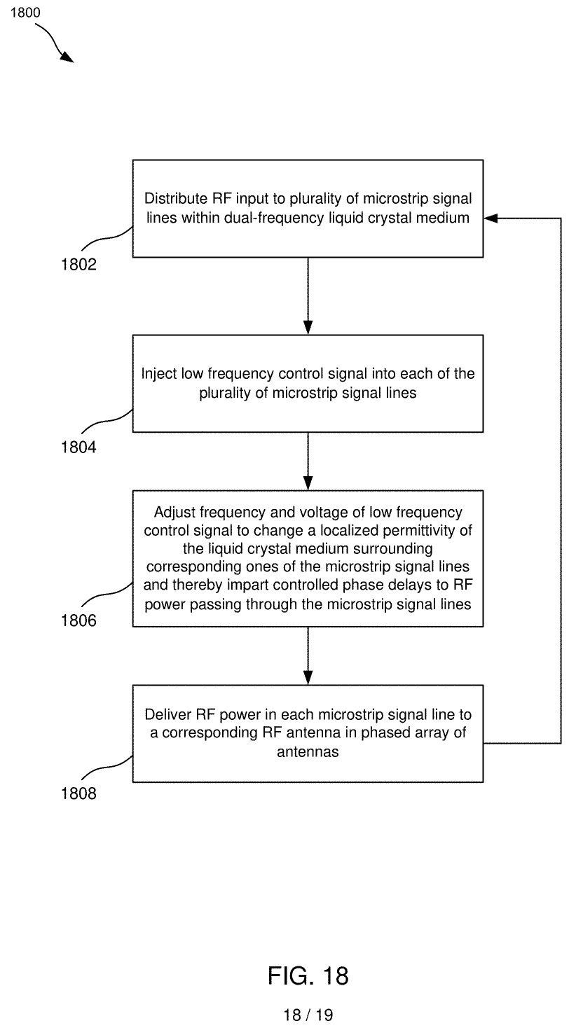

FIG. 18 illustrates an embodiment of a method for controlling a direction of a microwave beam generated by a phased array antenna. This method 1800 can be implemented via any of the systems illustrated and described relative to FIGS. 1-13 and 15. The method 1800 can include distributing an RF input to a plurality of microstrip signal lines within a dual-frequency liquid crystal medium (Block 1802). For instance, an RF power divider such as that shown in FIGS. 1 and 2 can perform this distribution. The method 1800 can inject a low frequency control signal into each of the plurality of microstrip signal lines (Block 1804) and adjust a frequency and voltage of the low frequency control signal to change a localized permittivity of the liquid crystal medium surrounding corresponding ones of the microstrip signal lines (Block 1806). This control imparts controlled phase delays to RF power passing through the microstrip signal lines. The control can be provided by AC bias electronics as generally shown as 106 and 206 in FIGS. 1 and 2, respectively, or more specifically by the circuits of FIGS. 9-13. FIGS. 14A and 14B provide an illustration of two exemplary low frequency control waveforms (solid lines), and the resulting change in liquid crystal permittivity in the vicinity of the corresponding signal line (dashed lines). The method 1800 can then deliver the RF power in each microstrip signal line to a corresponding RF antenna in the phased array antenna (Block 1808).

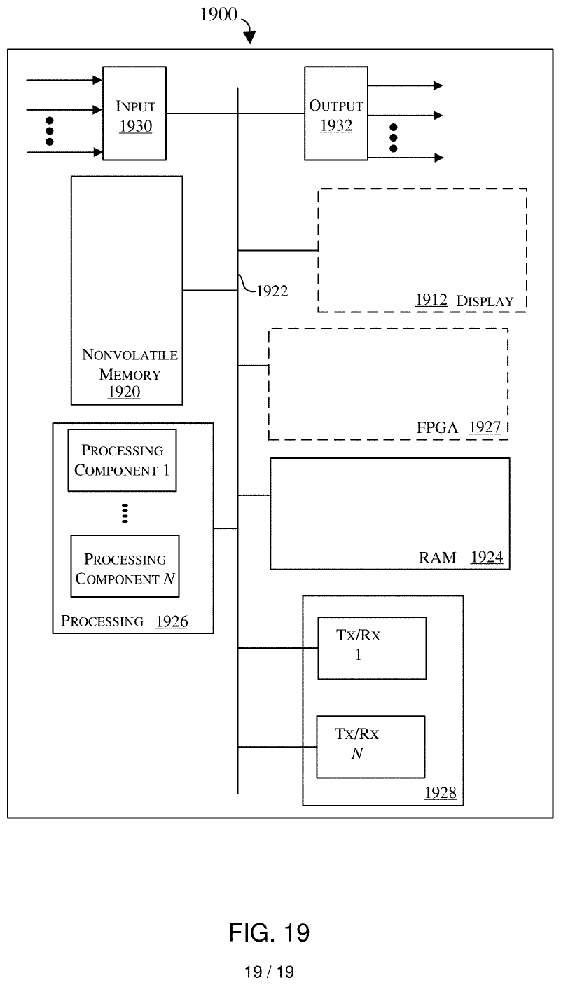

The methods described in connection with the embodiments disclosed herein may be embodied directly in hardware, in processor-executable code encoded in a non-transitory tangible processor readable storage medium, or in a combination of the two. Referring to FIG. 19 for example, shown is a block diagram depicting physical components that may be utilized to realize the microcontroller 900 (and the AC bias electronics 106 and 206 generally) according to an exemplary embodiment. As shown, in this embodiment an optional display portion 1912 and nonvolatile memory 1920 are coupled to a bus 1922 that is also coupled to random access memory (“RAM”) 1924, a processing portion (which includes N processing components) 1926, an optional field programmable gate array (FPGA) 1927, and a transceiver component 1928 that includes N transceivers. Although the components depicted in FIG. 19 represent physical components, FIG. 19 is not intended to be a detailed hardware diagram; thus many of the components depicted in FIG. 19 may be realized by common constructs or distributed among additional physical components. Moreover, it is contemplated that other existing and yet-to-be developed physical components and architectures may be utilized to implement the functional components described with reference to FIG. 19.

This optional display portion 1912 generally operates to provide a user interface for a user, and in several implementations, the display is realized by a touchscreen display. In general, the nonvolatile memory 1920 is non-transitory memory that functions to store (e.g., persistently store) data and processor-executable code (including executable code that is associated with effectuating the methods described herein). In some embodiments for example, the nonvolatile memory 1920 includes bootloader code, operating system code, file system code, and non-transitory processor-executable code to facilitate the execution of a method described with reference to FIG. 18 described further herein. The nonvolatile memory 1920 may also store voltage levels for the voltage pre-loader 901 as well as voltage and frequency signals to be used to control the bias electronics and provide a low frequency control signal to each of the signal lines in the liquid crystal medium. A mapping between (1) voltage and frequency and (2) changes to liquid crystal permittivity can also be stored in the nonvolatile memory 1920.

In many implementations, the nonvolatile memory 1920 is realized by flash memory (e.g., NAND or ONENAND memory), but it is contemplated that other memory types may be utilized as well. Although it may be possible to execute the code from the nonvolatile memory 1920, the executable code in the nonvolatile memory is typically loaded into RAM 1924 and executed by one or more of the N processing components in the processing portion 1926.

The N processing components in connection with RAM 1924 generally operate to execute the instructions stored in nonvolatile memory 1920 to enable control of the low frequency bias control signals. For example, non-transitory, processor-executable code to effectuate the methods described with reference to FIG. 18 may be persistently stored in nonvolatile memory 1920 and executed by the N processing components in connection with RAM 1924. As one of ordinarily skill in the art will appreciate, the processing portion 1926 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1926 may be configured to effectuate one or more aspects of the methodologies described herein (e.g., the method described with reference to FIG. 18). For example, non-transitory processor-readable instructions may be stored in the nonvolatile memory 1920 or in RAM 1924 and when executed on the processing portion 1926, cause the processing portion 1926 to perform a method of phased array antenna beam steering via changes to localized permittivity in a dual-frequency liquid crystal medium adjacent to signal lines. Alternatively, non-transitory FPGA-configuration-instructions may be persistently stored in nonvolatile memory 1920 and accessed by the processing portion 1926 (e.g., during boot up) to configure the hardware-configurable portions of the processing portion 1926 to effectuate the functions of the microcontroller 900 or the AC bias electronics 106 and 206.

The input component 1930 operates to receive signals (e.g., a direction of the beam) that are indicative of one or more aspects of the beam steering control. The signals received at the input component may include, for example, digital coordinates corresponding to a radial offset of the phased array beam from a zenith for a two-dimensional phased array. The output component generally operates to provide one or more analog or digital signals to effectuate an operational aspect of the AC bias electronics 106, 206. For example, the output portion 1932 may provide the voltage and frequency signals described with reference to FIGS. 9-13.

The depicted transceiver component2028 includes N transceiver chains, which may be used for communicating with external devices via wireless or wireline networks. Each of the N transceiver chains may represent a transceiver associated with a particular communication scheme (e.g., WiFi, Ethernet, Profibus, etc.). These transceiver chains may allow wireless control of the phased array, although wired control is also envisioned.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “notch” should be understood to encompass disclosure of the act of “indenting” or “burrowing”—whether explicitly discussed or not—and, conversely, were there only disclosure of the act of “indenting”, such a disclosure should be understood to encompass disclosure of an “indentation” or “notch”. Such changes and alternative terms are to be understood to be explicitly included in the description.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A driver for a microwave phased antenna array comprising:
(a) a circuit board section comprising:
an RF input configured to carry a high frequency signal;
N liquid crystal section inputs;
N liquid crystal section outputs each configured to couple to one of N RF antennas;
a means to distribute power from the RF input to the N low frequency liquid crystal section inputs;
N low frequency AC bias inputs each coupled to a corresponding one of the N liquid crystal section inputs;
a liquid crystal aperture or notch;
(b) a liquid crystal section arranged in the liquid crystal aperture or notch and in electrical communication with the N liquid crystal section outputs, the liquid crystal section comprising:
a liquid crystal medium with N signal lines passing therethrough, each of the N signal lines coupled to one of the N liquid crystal section inputs and one of the N liquid crystal section outputs;
(c) AC bias electronics coupled to the N low frequency AC bias inputs and configured to provide low frequency control signals to the N signal lines, the low frequency control signals controlling a phase delay of the high frequency signal on each of the N signal lines by changing a localized permittivity of the liquid crystal medium around each of the N signal lines.

2. The driver of claim 1, wherein the AC bias electronics are on the circuit board section.

3. The driver of claim 1, wherein the N signal lines are microstrip signal lines on an inner surface of a first substrate, wherein the liquid crystal section further comprises a ground plane on an inner surface of a second substrate, the inner surfaces of the first and second substrates facing each other, and wherein the liquid crystal medium is arranged between the inner surfaces of the first and second substrates.

4. The driver of claim 1, wherein the liquid crystal medium is a dual-frequency liquid crystal.

5. The driver of claim 4, wherein changes in voltage and frequency on the low frequency control signals change the localized permittivity of the dual-frequency liquid crystal.

6. The driver of claim 1, wherein changes in voltage and frequency on the low frequency control signals change the localized permittivity of the liquid crystal medium.

7. A phased-array antenna comprising:
(a) an array of N RF antennas;
(b) a circuit board section comprising:
an RF power divider configured to distribute a high frequency signal to N signal lines in a liquid crystal section;
(c) a liquid crystal section comprising a liquid crystal medium and the N signal lines, each of the N signal lines configured to carry a 1/N^{th} portion of the high frequency signal between the RF power divider and the array of N RF antennas; and
(d) bias electronics coupled to the RF power divider and configured to inject N low frequency control signals onto the N signal lines, a voltage and frequency of each of the N low frequency control signals controlling a localized permittivity of the liquid crystal medium around a corresponding one of the N signal lines such that the bias electronics effect beam steering of the array of N RF antennas.

8. The phased-array antenna of claim 7, wherein the bias electronics are on the circuit board section.

9. The phased-array antenna of claim 8, wherein the array of N RF antennas is on the circuit board section.

10. The phased-array antenna of claim 7, wherein the array of N RF antennas is on the circuit board section.

11. The phased-array antenna of claim 7, wherein the bias electronics, the liquid crystal section, and the array of N RF antennas are on separate circuit boards.

12. The phased-array antenna of claim 7, wherein the N signal lines are microstrip signal lines on an inner surface of a first substrate, wherein the liquid crystal section further comprises a ground plane on an inner surface of a second substrate, the inner surfaces of the first and second substrates facing each other, and wherein the liquid crystal medium is arranged between the inner surfaces of the first and second substrates.

13. The phased-array antenna of claim 7, wherein the RF power divider is of a planar waveguide topology.

14. The phased-array antenna of claim 13, wherein transitions from the planar waveguide topology of the RF power divider to a microstrip signal line topology of the N signal lines takes place on the liquid crystal section.

15. The phased-array antenna of claim 13, wherein transitions from the planar waveguide topology of the RF power divider to a microstrip signal line topology of the N signal lines takes place on the circuit board section.

16. The phased-array antenna of claim 7, wherein the liquid crystal medium is a dual-frequency liquid crystal.

17. The phased-array antenna of claim 16, wherein changes in voltage and frequency on the low frequency control signals change the localized permittivity of the dual-frequency liquid crystal.

18. The phased-array antenna of claim 7, wherein changes in voltage and frequency on the low frequency control signals change the localized permittivity of the liquid crystal medium.

19. A method for controlling a direction of a microwave beam generated by a phased array antenna, the method comprising:
distributing an RF input to a plurality of microstrip signal lines within a dual-frequency liquid crystal medium;
injecting low frequency control signals into the plurality of microstrip signal lines;
adjusting a frequency and voltage of at least one of the low frequency control signals to change a localized permittivity of the liquid crystal medium surrounding a corresponding one of the microstrip signal lines and thereby imparting controlled phase delay to RF power passing through the microstrip signal lines; and
delivering the RF power in each microstrip signal line to a corresponding RF antenna in the phased array antenna.

20. The method of claim 19, further comprising adjusting the controlled phase delays by adjusting both a voltage and frequency of the low frequency control signal for at least one of the plurality of microstrip signal lines.
